(19) United States
(12) Patent Application Publication
(10) Pub. No.: US 2016/0105124 A1
(43) Pub. Date: Apr. 14, 2016

(54) Energy Saving Power Supply Unit

(71) Applicant: Ardarius Varrez Cravens, San Ysidro, CA (US)

(72) Inventor: Ardarius Varrez Cravens, San Ysidro, CA (US)

(21) Appl. No.: 14/510,565

(22) Filed: Oct. 9, 2014

(51) Int. Cl. H02M 7/06

(52) U.S. Cl. CPC H02M 7/06

(57) ABSTRACT

The new energy saving power supply unit is designed to power and save 50% to 87.5% of electrical energy or power, consumed by appliances and other loads. The unit applies methods of circuit modifications, calculations and manipulations to produce time percentages of the 120 vac, 240 vac and 480 vac 50/60 Hz single phase sine wave power line outputs of the U.S and international power grids. The energy saving power unit can also be used with renewable energy systems. A switching timed controlled percentage of the 50/60 Hz operation of the line is developed in the front end circuits of the unit. Power efficiency methods are developed in the back end circuits of the unit. The new methods creates percentages of substantial energy savings of residential and commercial applications of the United States and international countries, the power generating companies and the world's electrical energy economy.

### CROSS REFERENCE TO RELATED APPLICATIONS

NOT APPLICABLE.

### STATEMENT REGARDING FEDERALLY SPONSORED RESEARCH OR DEVELOPMENT

NOT APPLICABLE.

### REFERENCE TO A SEQUENCE LISTING, A TABLE OR A COMPUTER PROGRAM LISTING COMPACT DISC APPENDIX

NOT APPLICABLE.

### BACKGROUND OF THE INVENTION

The Energy Saving Power Supply Unit pertains to the electrical power supply field. The unit supplies power or energy savings to both AC/DC appliances and loads. The unit relates to the U.S and International electrical grid companies that use power distribution lines to supply power to residential customers and to the commercial industries.

The Energy Saving Power Supply Unit is applied to the input of AC outlets. Appliances and loads are applied to the unit's AC outlet to accomplish energy savings of supplied power, generated by the electrical grid systems to customers. In the state of current technology, the units will contribute to savings of the world's electrical energy economy by a vast improved percentage.

### BRIEF SUMMARY OF THE INVENTION

The Energy Saving Power Supply Unit is a power supply designed to save electrical energy or power for AC and DC consumer appliances and other loads. The unit is powered by an AC source and uses a modification of voltage, frequency and time of a 60 Hz/16.7 ms sine wave signal, to supply of a timed controlled switching pulsed signal for powering 60 Hz or other line frequency, single phase operated loads, producing a pulsed waveform with a controlled time percentage value. Also to mimic full wave peak power, in a half wave generated signal.

Power is generated and supplied to the units by electrical distribution companies or renewable energy systems producing AC. The units can be powered by a combination of these sources operating in parallel and controlled via a metering system (Grid operated Renewable energy systems) resulting in a fully generated power and greater energy saving system. The Energy Saving Power Supply Unit presents the advantages of savings for both the energy generating companies and customers or consumers of electrical energy. (This benefits the world's electrical energy economy).

The Energy Saving Power Supply Unit saves 50 to 87.5% of energy used on appliances and loads therefore producing the same percentage of savings for the electrical energy consumers, as well as the power generating companies.

The Energy Saving Power Supply Unit, outputs switching voltages of 120 vdc, 240 vdc and 480 vdc and 2400 w to 4800 w for single phase applications in the United States and international countries. The unit regulates energy to 125 KW at a power consumption rate of 1 MW per month at the 87.5% savings and keeps energy well within the first tier bracket used by power companies to charge flat rates for energy usage.

The Energy Saving Power supply unit, in its saving processes, will allow the use of battery operated renewable energy system configurations, to power and save energy in homes, rural business or commercial areas, by saving on discharging times, therefore charging times of the battery source itself.

### BRIEF DESCRIPTION OF THE SEVERAL VIEWS OF THE DRAWING

FIG. 1A illustrates power source inputs and the reference frequency signal output for IC1.

FIG. 1B illustrates power source input, preset; mode, clock and latch enable signal inputs and signal clock output for the divide by n IC2.

FIG. 1C illustrates power source input, address and mode inputs and programmed outputs of IC3 to control IC2.

FIG. 1D illustrates power source input, preset, mode and clock inputs and binary count outputs of IC4.

FIG. 1E illustrates power source input, active low enable and binary count inputs and selected decoder output for IC2.

FIG. 1F illustrates power source input, comparator signal and voltage reference inputs and output for IC6.

FIG. 1G illustrates 120 vdc power source input, signal inputs to gates of mosfets IC7 through IC11 and voltages to output AC socket 2 and AC socket 4.

FIG. 1H illustrates the 120 vac power supply input distribution system from the line, to a 120 vac AC socket 1 input, high voltage rectification and filtering, switching power supply inputs, high and low voltage outputs.

FIG. 1I illustrates the 240 vac power supply input distribution system from the line to a 240 vac AC socket 3 inputs, high voltage rectifications and filtering, switching power supply inputs, high and low voltage outputs.

FIG. 1J illustrate a block diagram flow chart of components complete unit's working system, including FIG. 1A through FIG. 1I.

FIG. 1K illustrates a front view of the metal embodiment and panel components.

FIG. 1L illustrates a top view of the metal embodiment exposing front and back panel components and top air ventilation center screen and rim.

FIG. 1M illustrates a bottom view of the metal enclosure exposing bottom components.

### DETAIL DESCRIPTION OF THE INVENTION

The Energy Savings Power Supply Unit is designed to benefit customers consuming electrical energy on their AC and DC Appliances and other loads. The unit is made to operate at 50/60 Hz single phase line AC voltages, 120 vac, 240 vac and 480 vac, 2400 w to 4800 w for the United States and or 120 vac, 240 vac and 480 vac for international applications.

The unit is powered by AC sources supplied by the power grids and renewable energy systems. The unit can also be powered by a parallel configuration of grid and renewable energy, controlled via a metering system (Grid controlled Renewable Energy systems).

The unit outputs to the customer's AC and DC electrical appliances and loads. Methods of the Unit, used to save power or electrical energy, saves energy for the power generating companies, as well, also enhancing energy performance of battery operated renewable system by discharging and therefore the charging times of the battery sources. In the case of charging times, the battery source will not use the Energy Saving Power Supply Unit.

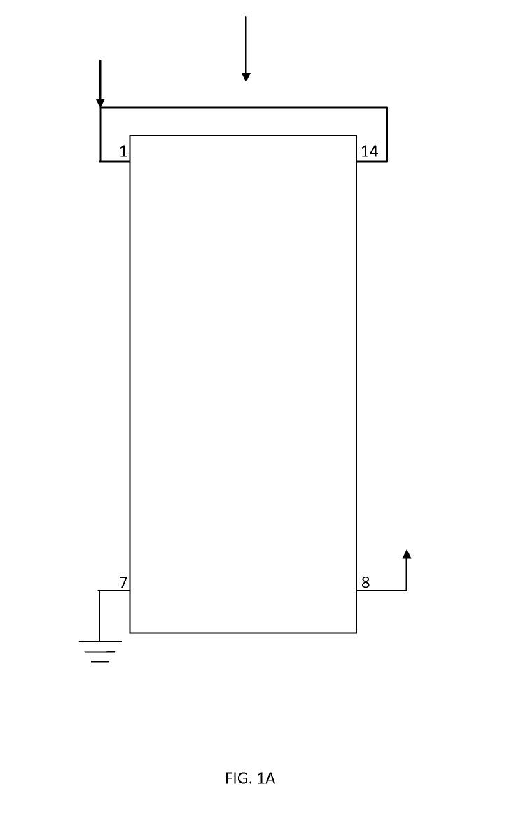

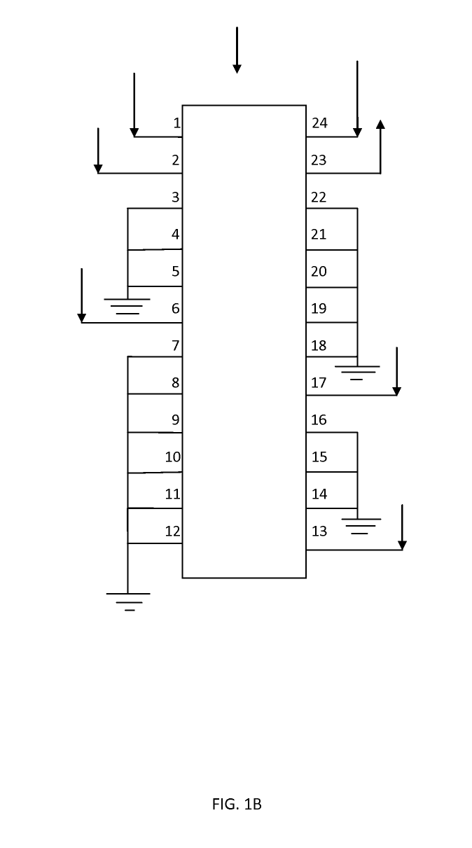

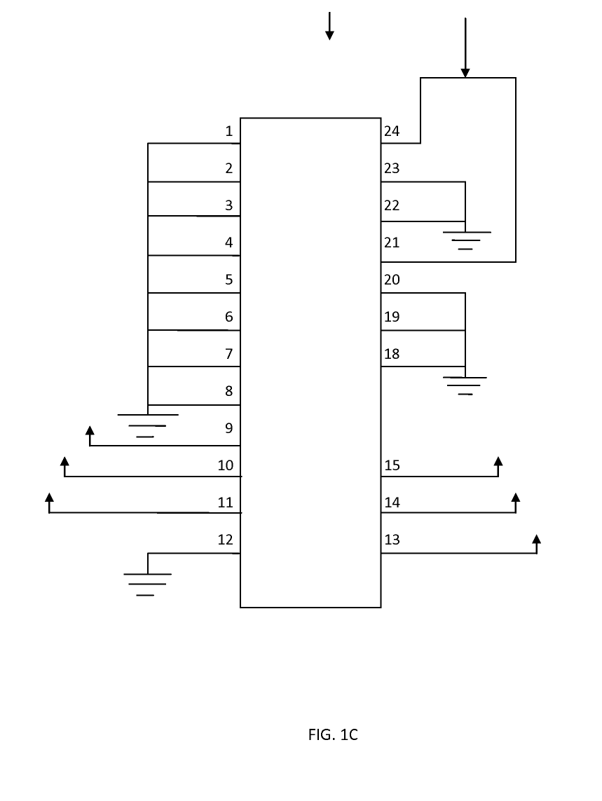

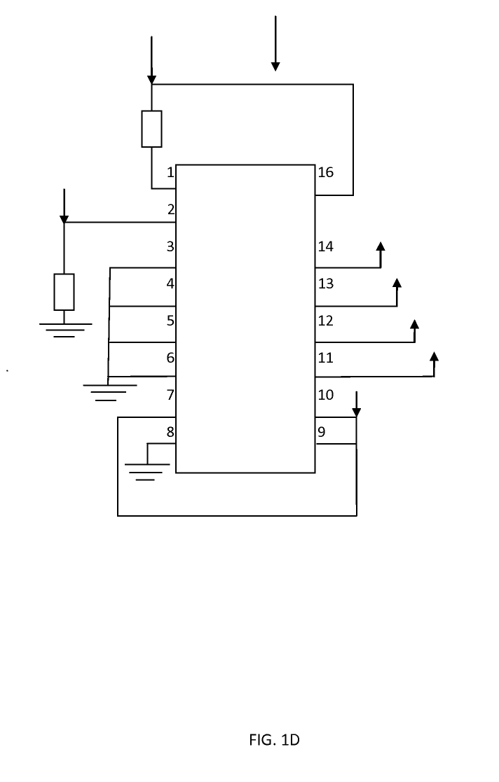

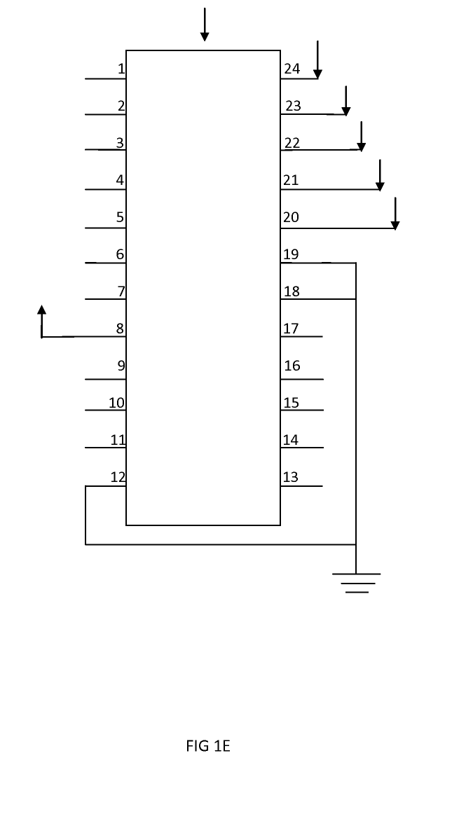

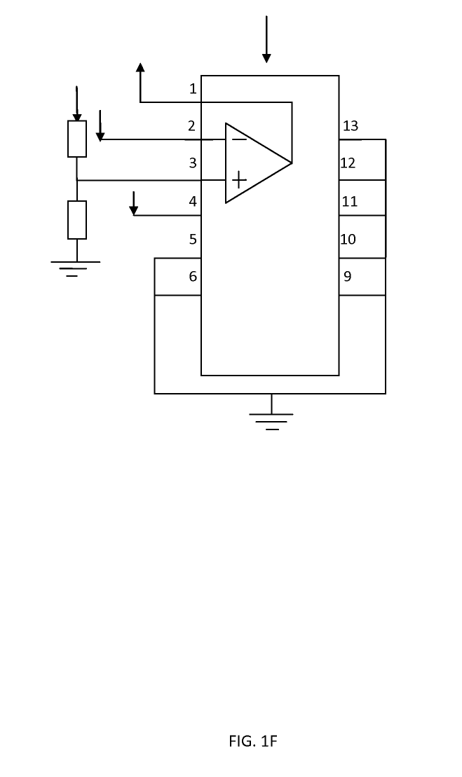

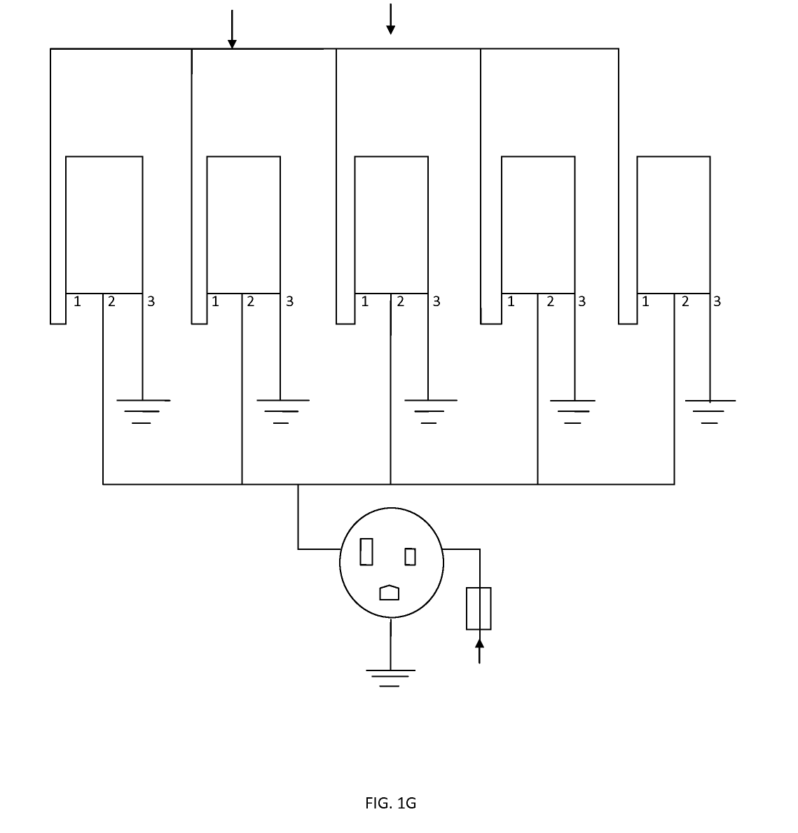

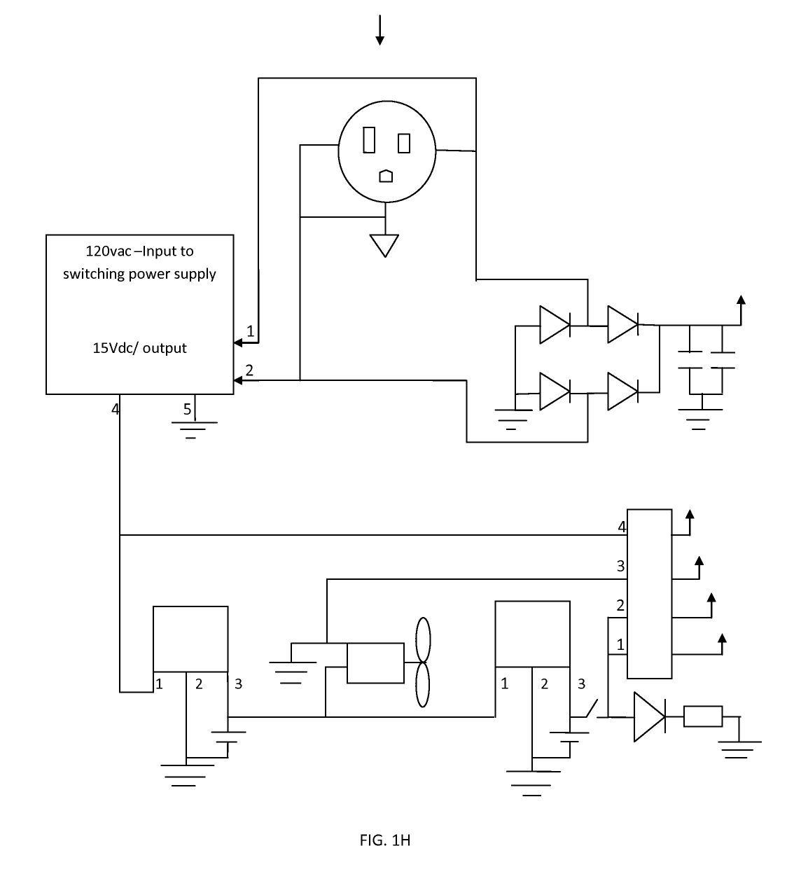

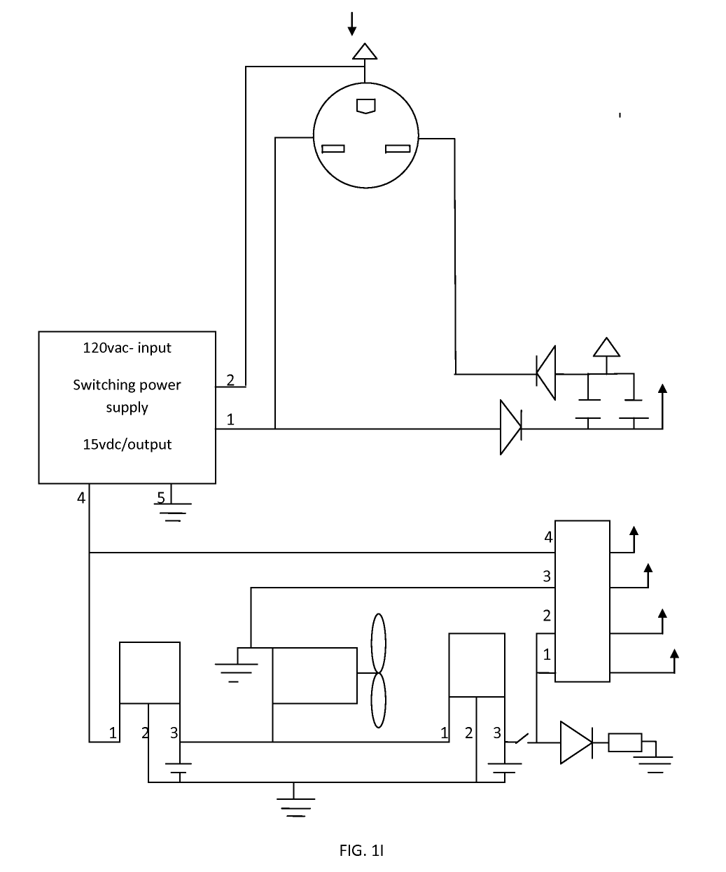

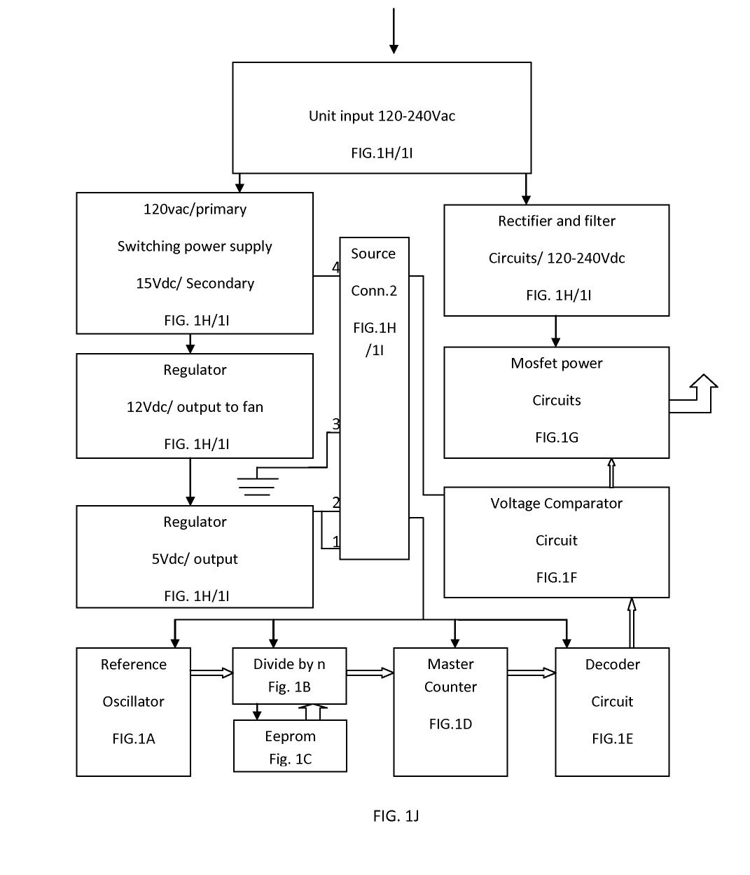

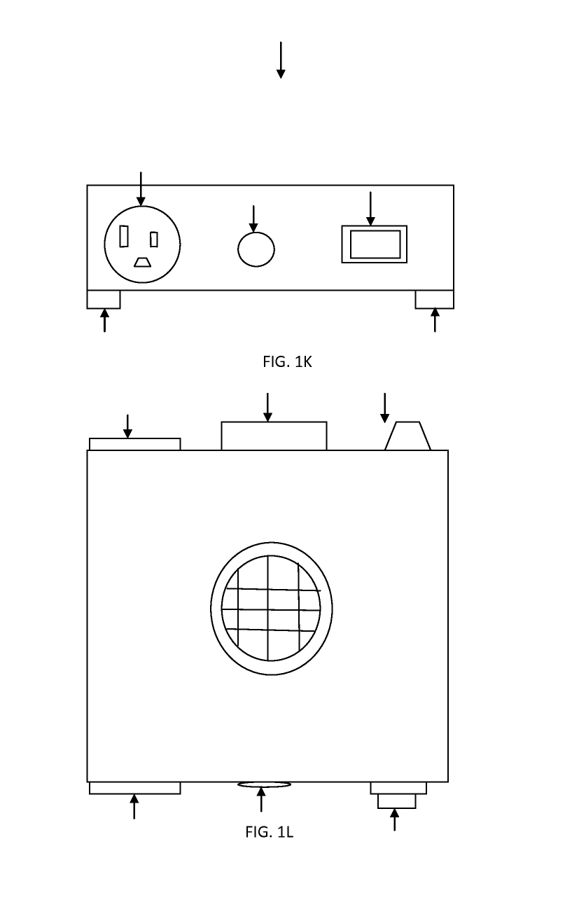

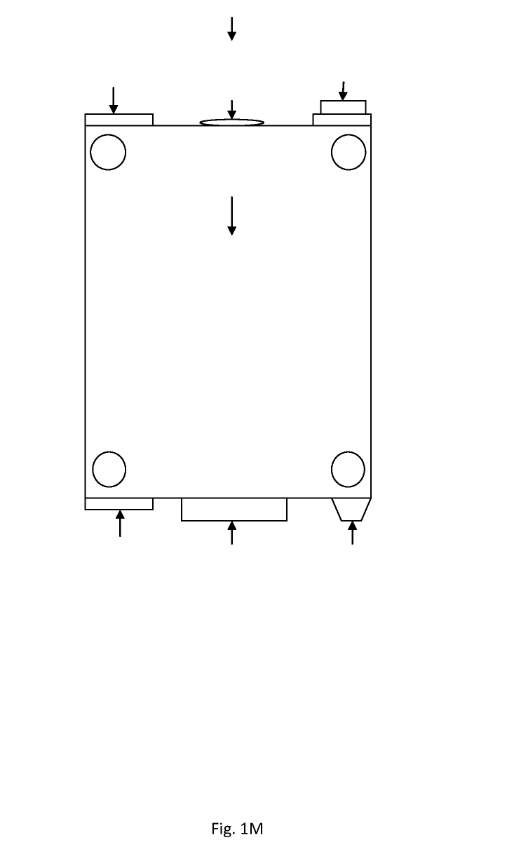

The Energy Saving Power Supply Unit uses methods to generate savings of electric power by rectification of the units input 120, 240 and 480 single phase AC voltages, a switching power supply that produce a 15 vdc output, 12 vdc and 5 vdc via regulators IC12, IC13, IC14 and IC15 in FIGS. 1H and 1I, powering the front and back end circuits of the unit. Circuit manipulations to a reference frequency IC1 in FIG. 1A, a programmable divide by n IC2 in FIG. 1B, a control Eeprom IC3 in FIG. 1C, a master counter IC4 in FIG. 1D, a count decoder/demultiplexer IC5 in FIG. 1E, a voltage comparator, inverter and voltage booster IC6 in FIG. 1F, and high power parallel switching circuits, of mosfet transistors IC7-IC11 in FIG. 1G.

The Energy Savings Power Supply Unit is separated into two operating sections. (The front end and the back end of the Unit). In FIG. 1A the front end employs a crystal clock oscillator IC1 a MX046; an enable high or +5 v at pin 1 allows a RF generated signal running at 1 MHz. The circuit is embodied inside a metal enclosed grounded case, for circuit protection against EMI.

This signal is outputted at pin 8 and used as the unit's reference signal to set a band of operating frequencies for the divide by n, to run at selected output frequencies. The reference frequency oscillator IC1 is powered by +5 v and ground of the low voltage power source connector 2; pins 2 and 3 are tied to pins 14 and 7 to power the IC. The reference oscillator outputs at pin 8 to the divide by n IC2, to pin 1 and is also used to set the units operating stability factor. The reference oscillator is the first circuit of the front end supporting the unit's energy savings and power processes.

The programmable divide by n, IC2 in FIG. 1B, a744059. The circuit is powered by +5 v and ground from the low voltage power source connector 1; pins 2 and 3 are tied to pins 24 and 12 to power the IC. The reference signal inputs at pin 1 and divides by a selectable mode of 2, 4, 5, 8 or 10 by pins 11, 13 and 14 mode inputs and from a preset value of 3 to 15,999, by selectable pins 3-10 and pins 15-22 preset inputs, to generate an operating frequency. Pin 2 of IC2 is a latch input. Pins 17 and 6 are the selected preset inputs. Pins 11, 13 and 14 are the divide mode inputs. IC2 in FIG. 1B presets are set to a value of 208 and mode inputs are set to divide by 10, to output 480 Hz for an 87.5% savings operation. All unused preset inputs are grounded as well as some selected presets.

The operating frequency produced at the divider's output, pin 23 produces a half wave, timed controlled pulses signal that is a percentage of a full wave sine output. In this manner the signal saves 50% to 87.5% of a 60 Hz/16.66 ms single phase sine wave, generated by the grid systems or other AC sources. The output signal at pin 23 are selected to operate at frequency multiples of 60 Hz starting with 120 Hz to 480 Hz and inputs to pin 2 of IC4. The programmable divide by n is the second circuit supporting the unit's front end energy savings and power processes.

IC3 in FIG. 1C, a 16 k (2 k×8K) Parallel Eeprom controls IC2, the programmable divide by n circuit. +5 v and ground of the low voltage power source connector 1; pins 2 and 3 are tied to pins 24 and 12, to power the Eeprom. Ground of the low voltage power source connector 1; pin 3 is tied to pins 1-8, 19, 22 and 23 of the Eeprom to set input addresses at a 0 or a low level.

+5 v of the low voltage power source connector 1; pin 1 is tied to pin 21. Ground of the low voltage source connector 1; pin 3 is tied to pins 18 and 20, to set read operations of the Eeprom. Output pins 9-11 and 13-15 are programmed to control preset inputs, mode inputs and the latch enable of the programmable divide by n circuit IC2. The Control Eeprom is the third Circuit supporting the unit's front end energy savings and power processes.

The master counter IC4 in FIG. 1D, a 74161 presettable 4 bit binary counter with asynchronous reset. +5 v and ground of the low voltage power source connector 1; pins 2 and 3 are tied to pins 16 and 8 of the master counter to power the circuit. 5 v of the low voltage power source connector 1; pin 1 is tied to pin 1 of the master counter via R1 a 10 k ohm resister, to keep a high level on the master reset pin. +5 v of the low voltage power source connector 1; pin 1 is tied to pins 7, 9 and 10 to disable the operating modes. Ground of the low voltage power source connector 1; pin 3 is tied to pins 3 through 6, of the master counter, to disable the preset inputs.

The output frequency signal at IC2, pin 23 of the divide by n counter, inputs to pin 2 of the master counter IC4 to count pulses. Ground of the low voltage power source connector 1; pin 3 is tied to pin 2 of the master counter via R2, a 10 k ohm resistor to set a low voltage level reference. The output is taken from pins 11, 12, 13 and 14 and generates a binary code or count sequence that synchronizes with the output frequency input clock pulses. This method prepares the signal to input to the decoder circuit. The master counter is the fourth circuit of the front end, supporting the unit's energy savings and power processes.

IC5 in FIG. 1E, a 74154 4 to 16 lines Decoder/Demultiplexer. Outputs from IC4, pins 11, 12, 13 and 14 are tied to pins 20, 21, 22 and 23 of the decoder, to access IC5 addresses sequentially. IC5 outputs at pins (1-11) and (13-17). +5v and ground of the low voltage power source connector 2; pins 2 and 3 are tied to pins 24 and 12 of the decoder circuit to power the IC. Each address Produce 16 sequential active low outputs stored from the decoder's memory.

A single output from the decoder is selected to synchronize to the operating frequency signal developed at the divide by n circuit IC2 and the codes or counts generated at the outputs of the master counter circuit IC4. Ground of the low voltage power source connector 1; pin 3 is tied to pins 18 and 19 of the decoder circuit, to enable operations. The decoder outputs at pin 8 to the voltage comparator IC6 in FIG. 1F, pin 2, to amplify and invert the small 2 v and 0 v output signals to the 15 v and 0 v supply level of IC6 output. The output of the decoder produces the final 60 Hz, for an 87.5% energy saving operation of the unit. The decoder is the fifth and final circuit of the front end and supports the unit's energy savings and power processes.

The voltage comparator IC6 in FIG. 1F consists of an LM324 quad operational amplifier. The circuit is powered with 15 v and ground from the low voltage power source connector 1; pins 4 and 3 to pins 4 and 11 of IC6. +2 v and 0 v logic levels from pin 23, the output of the decoder circuit IC5, ties to pin 2 of the inverting input. Input at pin 3 is taken from the junction of R3 an 8K and R4 a 2K ohm resistors, powered by +5 v and ground to set a reference of 1 volt on the noninverting input. Ground of the low voltage power source connector 1; pin 3 is tied to pins 5, 6, 9, 10, 12 and 13 for unused inputs of the circuit.

The input and reference voltages are compared. The output voltages are inverted and boosted or amplified to the 15 v supply and ground level of IC6 at pin 1. The voltage comparator output at pin 1, buffers the front end circuits to the switching power mosfets and is the first circuit of the back end supporting the unit's energy savings and power processes.

The switching power mosfets IC7-IC11 from left to right in FIG. 1G, inputs the amplified switching signal at pin 1, the gates of IXFTBON50P3, a 5 stage parallel power mosfet circuit, from pin 1 of the voltage amplifier, to switch the voltage, high current supply, via source pin 3 to drain pin 2 of the power mosfets, to power the output AC appliance and load circuits via a selected 15, 25 and 40 amp fuses and high voltage DC supply. The high voltage DC output is tied to the hot pin via selected 15-40 amp fuses to the unit's output AC socket 2 for 120 vac and output AC socket 4 for 240 vac units.

The drain is tied to the neutral pin of the unit's output AC socket 2 and output socket 4. Ground is tied to the ground pin of the unit's output AC socket 2 and output socket 4. AC appliance and other loads are inputted between the hot pin and neutral pin for 120 vac or 240 vac, of the unit's output socket 2 and socket 4, to be energized.

The parallel configuration produces current and power sharing of the power mosfets. They are powered with 120 vdc, 240 vdc and 480 vdc, switching at a time controlled final frequency of 50/60 Hz to power single and split phase products and selected to supply 2400 w and more of output power for the United States and international, residential and commercial applications. The switching power mosfet configurations are the second and last circuits of the back end, supporting the unit's energy savings power processes.

The prototype units excepts non grounded and grounded receptacle applications and are powered with 120/240 vac single phase voltages of the grid line tied to the input AC socket 1 and input AC socket 3. SW1 and SW2 controls the on and off power manually from +5 v supply, to the front end circuits. Ac voltages inputs to high voltage rectifiers and filter circuits D1-D4, C3 and C4 producing a 120 vdc half wave pulse to power C7-C11 power mosfet circuits. D5-D6, C3 and C4 producing 240 vac half wave rectification from three or four wire receptacles and cord applications, also 120 vac of both AC supplies inputs to switching power supplies primary windings pin 1 and 2 in FIG. 1H and 1I. Hot, Neutral and ground of a 120 AC cord inputs to the hot, neutral and ground terminals of the unit's AC input socket 1. When power is switched on, the LED 1 and Led 2 indicator lights illuminates yellow via a +5 v regulator and current limiting 830 ohm resistors R5 and R6, to verify presence of input power.

The prototype unit powered with 240 vac three or four wire split phase AC, inputs to socket 3 and will follow the same circuit configuration, except socket 3 input configurations and two diode full wave rectifiers D5 and D6, filter circuits C3 and C4, used to produce the 240 vdc pulsed power output to power C7-C11 power mosfets circuits and loads at the output AC socket 4 via a selected 15-40 amp fuse. Hot and ground is tapped from the three or four wire 240 vac input AC socket 3 and produce 120 vac to safely power the switching power supply. Hot to hot and ground of a receptacle and AC cord inputs to the hot to hot and ground terminals of the AC input socket 3.

The secondary of the switching power supply, produces a regulated +15 vdc. Three voltage outputs powers the front end circuits and a back end circuit of the energy saving power supply via source connector 1; and directly. +5 vdc powers Led 1 and Led 2 power indicators directly via 830 ohm series resistors and the front end circuits via source connector 1. +15 vdc powers the voltage comparator IC6 via source connector 1; a circuit of the back end and a +12 v regulator directly. +12 vdc powers a single cooling fan and a +5 vdc regulator directly. C5, C6, C7 and C8 are 100 uf filter capacitors to prevent oscillations or noise for the 12 volt and 5 v regulators IC12, IC13, IC14 and IC15.

The 120 and 240 vac input voltages in the prototypes are applied to high voltage rectifier and filter circuits D1-D4, C1 and C2, D5, D6, C3 and C4 to produce high dc voltages to power the 5 stage parallel mosfet circuits, AC, DC appliances and other loads. The hot terminals of the output AC socket 2 and socket 4 of the prototypes are tied to 120 and 240 vdc via selected 15-40 amp fuses. The neutral terminals of the output AC sockets are tied to pin 2 the drains of the mosfet circuits. Ground of the AC output sockets are tied to ground. Ground is also tied to the unit chassis. The AC and DC appliances and other loads are applied between pins 120 vdc-(hot) and drain-(neutral) of the unit's output AC socket 2 and AC socket 4, 240 vdc follows the same circuit configuration of output socket 2.

The Energy Saving Power Supply Unit, working modes begin with methods of calculations that set the Unit from 50% to 87.5% of energy savings. The calculations are of an offset percentage produced from a desired percentage of energy savings. The calculations are of an offset operating frequency produced from a desired operating frequency. The calculations are of an offset timed controlled switching signal produced from a desired timed controlled switching signal; also selection of a single decoder output is made to synchronize to operations of the front end circuits.

All percentage factors are multiplied by 16.66 milliseconds (87%×0.0166) to accomplish a percentage of electrical energy savings in the Power Supply Unit. One half wave form is generated to match a percentage of a complete full 60 Hz/16.66 ms sine wave generated from the electrical Grid companies to supply power to AC and DC Appliances and other Loads.

The percentage wave is a modified pulsed wave, switching 120 vdc, 240 vdc and 480 vdc of rectified AC or (DC voltages). The complete time of loads consuming power is shortened. The modified pulse wave switches in the modified voltages and becomes a timed controlled energy saving percentage of the 16.66 ms line operated sine wave signal. The operating frequency producing a time controlled percentage signal and working along with a single selected decoder output will develop a synchronized operation of the circuits at the front end of the Energy Saving Power Supply.

To calculate for desired percentage of frequency, a time controlled signal and to select a synchronized decoder output. Multiply a desired percent by 16.66 ms (87%×0.0166)=(14.49 ms). This value is subtracted from 16.66 ms. (16.66 ms−14.49 ms)=(2.17 ms). This is the desired time percentage of the grid line AC signal. Perform the inverse of the desired time controlled signal to come to a desired frequency. (1/0.00217)=(460.8 Hz). This value is the desired operating frequency. Start to round off the value of the desired operating frequency to a whole value. (460.8)=(460 Hz). Divide the whole value by the main operating frequency (60 Hz).

(460 Hz/60 Hz)=7.66 Hz. This value is selected for a single decoder output it must be a whole value×60 Hz. Round off this value to a whole number (7.66)=(8.0). Multiply whole number by (60 Hz). (8.0×60 Hz)=(480 Hz). This value has become the new operating frequency offset value. To come to an offset time controlled signal perform the inverse of the offset operating frequency.

(1/480 Hz)=(2.08 ms).This is the new and permanent time controlled signal offset. Divide permanent offset timing by 16.66 ms to get the final offset percentage. (2.08 ms/16.66 ms)=87.5% an increased margin of +0.5. This value is the permanent offset percentage value of the unit. The operation margins are developed as a result of the difference between the desired and offset percentages of the unit's operating circuits. To calculate for divide by n preset values, divide reference frequency by offset operating frequency. (1 MHz/480 Hz)=(2080 Hz). Divide preset value by 10 the selected divide mode. (2080/10)=208. This value is the preset input value of the divide by n circuit.

This method of calculating true operating percentages is totally designed and used for output accuracy of the Energy Saving Power Supply Unit. The Unit is used to supply power savings to systems, appliances and other loads of a residential and commercial entity, while saving a substantial amount in energy consumption for customers and the power generating companies.

The Energy Saving Power Supply Unit is used with a parallel connected assembly (the units extended power outlets) of AC wall outlets, designed to be installed on the walls in each room of residential and commercial buildings. A distribution method involving three power source wires, to input and power each wall outlet in the assembly. The unit's output supplies an AC cord to the first extended power outlet involving a two socket plug outlet. Three power wires extend from the first outlet to all other outlets installed in selected or each room of a residential or commercial building. Appliances and other loads that use single phase voltages are powered from the output of the Energy Saving Power Supply Unit via this method. The Unit inputs to the 60 Hz/16.66 ms AC wall outlet to be energized.

Energy surge outlet strips can be used to input to the extended parallel wall outlets to protect appliances and other loads from surges of the power line and to protect the power supply from any current over loading of powered products. The extended parallel configuration is designed to support multiple appliances and other loads in all rooms of a building.

The Energy Saving Power Supply Unit extended parallel assembly and power wires distribution method, is also used with battery operated and various renewable Energy Systems in a standby/standalone configuration. The Units method of powering each room of a Residential and or Commercial building is a complete operating system used to accommodate savings of electrical power, generated from the power Grid companies, renewable energy systems and other AC potential sources.

The Energy Saving Power supply Unit's prototype is made with a (6×6 electronic component project board) for assembling components onto the surface of the board, using a method called through whole soldering. Circuit components are pretested for values, tolerances, input and output (signal data and voltage levels) to ensure component specifications and to save time in the circuit component assembly process.

Components related to the front and back end circuits of the Energy Saving Power supply Unit are installed and soldered onto the surface of the (electronic component project board). Power circuits in FIG. 1H and 1I, consisting of a high voltage AC power supply, rectifier and filter circuits (high voltage DC power supply, a switching power supply, two regulator circuits and a low voltage connector are installed and soldered onto the surface of the (electronics component project board). AC input and output sockets are installed on each prototype of the unit's front left side and left back side side housing of the enclosure.

An Indicator led lamp is installed in the middle of the front housings for both prototypes. Power on and off switches is installed on the right side of the front housing. Low voltage dc source connector 1 are installed and soldered onto the surface of the (electronic components project board). Metal heat sinks for a five parallel configuration of mosfet circuitry are installed and soldered onto the surface of the (electronic components project board).

A Metal enclosure in FIGS. 1K-1M, houses the (electronic components project board). A cooling fan is installed and screwed into the middle outside back housing of the (metal enclosure). A fuse is installed in a fuse holder via the left outside back housing of the (metal enclosure). Four rubber stand offs or feet are installed on the bottom of the housing. A Ventilation, rim and screen, are installed in the center on the top of the metal enclosure. The top and bottom of the housing is fastened together by four screws on the underside of the bottom of the housing. The process of making the Energy Saving Power Supply Unit begins with installing and soldering components related to the front end circuits onto the surface of the (electronic components project board).

The process of making the Energy Savings Power Supply Unit. Starts with the reference oscillator IC1 in FIG. 1A. This is the first circuit of the unit's front end, installed and soldered onto the surface of the electronic components project board. +5 v and ground of the low voltage power source connector 1; pins 2 and 3 are tied to pins 14 and 7 of the reference oscillator.

+5 v of the low voltage power source connector 1; pin 1 is tied to pin 7 of the reference oscillator. The output of the reference oscillator is taken at pin 8. Proceeding installation and solder connections of circuit components, the oscillator is tested to ensure operations and output specifications.

The reference oscillator output, pin 8 is tied to pin 1, the input of the programmable divide by n counter IC2 in FIG. 1B is the second circuit of the unit's front end, installed and soldered onto the surface of the electronic components project board. +5 v and ground of the low voltage power source connector 1; pins 2 and 3 are tied to pins 24 and 12 of IC2. Ground of the low voltage power source connector 1; pin 3 is tied to pins 3-10 and 15-18 of IC2. The output is taken at pin 23.

+5 v and ground of the low voltage power source connector 1; pins 2 and 3 are tied to pins 24 and 12 of IC3 in FIG. 1C. The Eeprom is the third circuit of the unit's front end installed and soldered onto the surface of the electronics components project board. Ground of the low voltage power source connector 1; pin 3 is tied to pins 1-8, 19, 22 and 23 of the Eeprom. Ground of the low voltage power source connector 1; pin 3 is tied to pins 18 and 20. +5 v of the low voltage power source connector 1; pin 1 is tied to pin 21 of the Eeprom.

Programmed outputs, pins 9, 10, 11, and 13-17 of the Eeprom IC3 are tied to pins 2, 19-22, 11, 13 and 14 of the programmable divide by n counter IC2. Proceeding installation and solder connections of the circuit components, IC2 and IC3 circuit is tested with the RF output signal of the reference oscillator to ensure for operations and output specifications.

The output of the programmable divider IC2 pin 23 is tied to pin 2 of a presettable 4 bit binary counter with asynchronous reset (the master counter circuit). The master counter IC4 in FIG. 1D is the fourth circuit of the unit's front end, installed and soldered onto the surface of the (electronic components project board). +5 v and ground of the low voltage power source connector 1; pins 2 and 3 are tied to pins 16 and 8 of the master counter. +5 v of the low voltage power source connector 1; pin 1 are tied to pin 1 via R1. Ground of the low voltage power source connector 1; is tied to pin 2 of IC4 via R2.

Ground of the low voltage power source connector 1; pin 3 is tied to pins 3-6 of the master counter. +5 v of the low voltage power source connector 1; pin 1 is tied to pins 7, 9 and 10. Outputs are taken from pins 11-14 of the master counter circuit. Proceeding installation and solder connections of circuit components, the master counter is tested with prior assembled circuitry of the front end to ensure for operations and output specifications.

The outputs of the master counter pins 11-14 are tied to pins 20-23 of the decoder/demultiplexer circuit. The decoder IC5 in FIG. 1E is the fifth and last circuit of the unit's front end, installed and soldered onto the surface of the electronic components project board. +5 v and ground, pins 2 and 3 of the low voltage power source connector 1; are tied to pins 24 and 12 of the decoder.

Ground, pin 3 of the low voltage power source connector 1; pin 3 is tied to pins 18 and 19 of the decoder. The decoder outputs are taken at a single pin, from pins 1-11 and 13-17, pin 8 is selected for the prototype outputs. Proceeding installation and solder connections of circuit components, the decoder is tested by all prior assembled circuits of the unit's front end to ensure for operations and output specifications.

A single supply quad operational amplifier IC6 in FIG. 1F is the first circuit of the unit's back end, installed and soldered onto the surface of the electronic components project board. +15 v and ground of the low voltage power source connector 1; pins 4 and 3 are tied to pins 4 and 11 of the voltage amplifier. +5 v and Ground, pin 2 and 3 of the low voltage power source connector 1; are applied to a voltage divider circuit of an R3 and R4 resistors.

The junction of the divider is tied to pin 3. Ground, pin 3 of the low voltage power source connector 1; is tied to pins 5,6,9,10,12 and 13. The output is taken from pin 1 of IC6. Proceeding installation and solder connection of circuit components, the voltage comparator is tested by all prior assembled circuits of the unit, to ensure operations and output specifications.

The output of the voltage comparator pin 1 is tied to pins 1, the gate inputs of a 5 parallel mosfet circuit configuration. The switching power mosfets IC7-IC11 in FIG. 1G is the back end second and final circuits processing power via a switching method. Installed and soldered onto the electronic components project board. 120 vdc to 240 vdc and ground in FIG. 1H, are tied to pins 2 and 3 of the power mosfets.

The AC inputs power, high voltage DC outputs and switching power supply voltages in FIG. 1H and FIG. 1I distributes power throughout the front and back end circuits of the 120 and 240 vac prototype units. The power supply circuits are installed and soldered onto the surface of (the electronic components project board). Hot, neutral and ground of AC input socket 1, 120 vac are tied to pins 1 and 2, the input of the switching power supply and are inputted to the high voltage AC rectifiers and filter circuits. DC taps are taken from the output of the rectifiers and filter circuits D1-D4, C1-C2. Hot to hot and ground source are tied to hot to hot and ground of input AC socket 3 and inputted to rectifier and filter circuits. A 120 vac tap is taken from 240 Vac to safely energize the switching power supply. A high voltage DC tap is taken from D5, D6, C3 and C4.

The Rectified 120 vdc and 240 vdc high voltage DC power sources; is tied to the hot pin of AC socket 2 and AC socket 4 via selected 15-40 amp fuses in series with the output loads. Drain of the mosfets circuits are tied to the neutral terminal of AC socket 2 and AC socket 4. Ground, of the high voltage DC power source is tied to pin 3 of the mosfet source circuits, Circuits and chassis grounds and ground of the output AC socket 2 and socket 4. The secondary of the switching power supplies, 15 vdc output and ground, Pins 4 and 5, are tied to pins 4 and 3 of the low voltage source connector 1, also pins 2 and 3, the input of a 12 v regulator.

Pins 4 and 5, the output of the switching power supply, also are tied to pins 4 and 11 via connector 1, to power the voltage comparator and inverting amplifier circuits of the Unit's back end. Pins 2 and 3, output of the 12 vdc regulator is tied to the unit's cooling fan and pins 1 and 2, the input of the 5 vdc regulator directly. Pins 2 and 3 of the 5 vdc output are tied to the entire front end via connector 1 pins 1-3. The +5 v regulator is tied directly to switch SW1 and SW2. When these switches are manually closed. Led 1 and Led 2 are connected and illuminates yellow to indicate unit power flow. Proceeding installation and solder connection of circuit components, the switching power supply and high voltage rectifier outputs are tested with all prior installed front and back end circuits to ensure output operations and specifications.

1. I claim the entire electronic, electrical and mechanical system design of the energy saving power supply unit.

2. I claim the unit's AC voltage sources, front and back end circuits modifications.
The front end circuit of claim 2 designed to generate the unit's reference frequency and stability factor.
The front end circuit of claim 2 designed to generate the unit's divide by n operating frequencies and timed controlled DC pulsating output, producing the unit's energy saving percentages of 50% to 87.5%.
The front end circuit of claim 2 programmed Eeprom with preset, mode and latch data for controlling the unit's divide by n.
The front end circuit of claim 2 designed to generate binary codes to select decoder memory addresses via the unit's master counter.
The front end circuit of claim 2 designed to generate a synchronized single 50/60 Hz final output via the unit's decoder.
The back end circuit of claim 2 designed to generate the front end circuits referenced inputs, inverted and amplified voltage outputs and front to back end circuits buffering via the unit's voltage comparator.
The back end circuits of claim 2 designed to switch efficient power of a five stage power mosfet configuration at 50/60 HZ to energize AC and DC appliances and other loads.
The high 120, 240 and 480 vac input, single phase voltage sources of claim 2 modified to generate 120, 240 and 480 Vdc to energize the unit's power mosfets, single phase AC appliances and other loads.
The high 120 vac and 120 vac tapped from 240 vac input voltage sources of claim 2, to safely energize a switching power supply primary input, producing low DC output secondary voltages to power the unit's front end circuits and a back end circuit.

3. I claim the unit's calculation techniques of producing preset, mode, operating frequency values; a synchronized single 50/60 Hz output and timed controlled percentages of grid's AC high voltages.

4. I claim the unit's design to input and modify renewable energy AC voltages via grid tie or stand along systems.

5. I claim the unit's design to enhance battery powered applications increasing discharging times and decreasing charging times of stored energy, by the unit's energy saving percentages.

6. I claim the design techniques of the unit's extension receptacles and wiring assembly for unit use in selected or all rooms of residential and commercial buildings.
